(19) United States
(12) Patent Application Publication
(10) Pub. No.: US 2004/0114178 A1
(43) Pub. Date: Jun. 17, 2004

(54) SCANNING COPIER WITH MULTIPLE SELECTABLE PRINTERS

(76) Inventors: Michael Chen, Hsin-Chu City (TW); Po-Sheng Shih, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,919

(22) Filed: Aug. 27, 2003

Related U.S. Application Data
(63) Continuation-in-part of application No. 09/378,701, filed on Aug. 23, 1999, now abandoned.

(51) Int. Cl. G06F 3/12; G06F 13/00

(52) U.S. Cl. 358/1.15; 358/1.16; 710/38; 710/52

(57) ABSTRACT

A scanning copier includes a housing, a scanning module installed in the housing for scanning a document and generating corresponding image data, a control unit installed in the housing for controlling operations of the scanning copier, and a first printer installed inside the housing. A second printer is externally connected or installed inside the housing. A printer selecting device is electrically connected to the control unit for selecting one of the two printers as an output device. When the scanning module finishes scanning a document, the control unit transmits the image data of the document to the printer selected by the printer selecting device so as to print the document.

### CROSS REFERENCE TO RELATED APPLICATIONS

This is a continuation-in-part of application Ser. No. 09/378,701, filed Aug. 23, 1999, which is included in its entirety herein by reference.

### BACKGROUND OF INVENTION

1. Field of the Invention

The invention relates to a scanning copier, and more particularly, to a scanning copier with multiple selectable internal and external printers.

2. Description of the Prior Art

Please refer to Fi_Hlt489955837g_Hlt489955837.1. Fi_Hlt489956450g_Hlt489956450.1 is a functional block diagram of a prior art scanning copier 10. The scanning copier 10 comprises a scanning module 12 for scanning a document and generating corresponding image data, a control unit 14 for controlling operations of the scanning copier 10, an output port 16 electrically connected to the control unit 14 for connecting a printer 18, a memory 20 for storing the image data generated by the scanning module 12, a connecting port 22 electrically connected to the control unit 14 for connecting a computer 24, and a user interface 21. The control unit 14 comprises an image processing unit 13 for processing image data, and a central processing unit 15 for controlling the scanning process.

After the scanning module 12 finishes scanning a document, the control unit 14 transmits the image data of the document to the computer 24 through the connecting port 22. After the computer 24 processes the image data, the image data is transmitted to the printer 18 through the control unit 14 for being printed out. Alternatively, the scanning copier 10 need not be connected to the computer 24. In this scheme, the control unit 14 transmits the image data of the document stored in the memory 20 to the printer 18 through the output port 16 for printing out.

The prior art scanning copier 10 has only one output port 16 for being connected to one printer 18. For example, the scanning copier 10 can be connected to a black-and-white laser printer or a color inkjet printer. However, printing requirements, such as speed or color, are often changed. The black-and-white laser printer has a rapid printing speed, but can only print in black and white. The color inkjet printer can print in color, albeit very slowly. A color laser printer prints in color and at a good speed but is far too expensive for a general user. Some printers have special printing functions and effects and are very popular, such as a photo printer. However, the prior art scanning copier 10 can only be connected to one printer 18 at a time. If printing requirements change, the printer 18 must be changed accordingly. This is very troublesome to the user.

### SUMMARY OF INVENTION

It is therefore a primary objective of the present invention to provide a scanning copier with multiple selectable printers to solve the above-mentioned problem.

Briefly summarized, an embodiment of the present invention provides a scanning copier comprising a housing, a scanning module installed in the housing, a control unit installed in the housing, a first printer installed inside the housing and directly electrically connected to the control unit, a second output port electrically connected to the control unit for connecting an external second printer, and a printer selecting device electrically connected to the control unit. When the scanning module finishes scanning a document, the control unit transmits image data of the document to the printer selected by the printer selecting device so as to print the document.

Another embodiment of the present invention provides a scanning copier comprising a housing, a scanning module installed in the housing, a control unit installed in the housing, a first printer installed inside the housing and directly electrically connected to the control unit, a second printer installed in the housing and directly electrically connected to the control unit, and a printer selecting device electrically connected to the control unit. When the scanning module finishes scanning a document, the control unit transmits image data of the document to the printer selected by the printer selecting device so as to print the document.

It is an advantage of the present invention that the scanning copier allows multiple printer configurations through external and internal removable connections and direct internal portless connections.

It is a further advantage of the present invention that the printer selecting device allows selection of a printer based on user requirements, and no manual changing of printers is required.

These and other objectives and the advantages of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a functional block diagram of a prior art scanning copier.

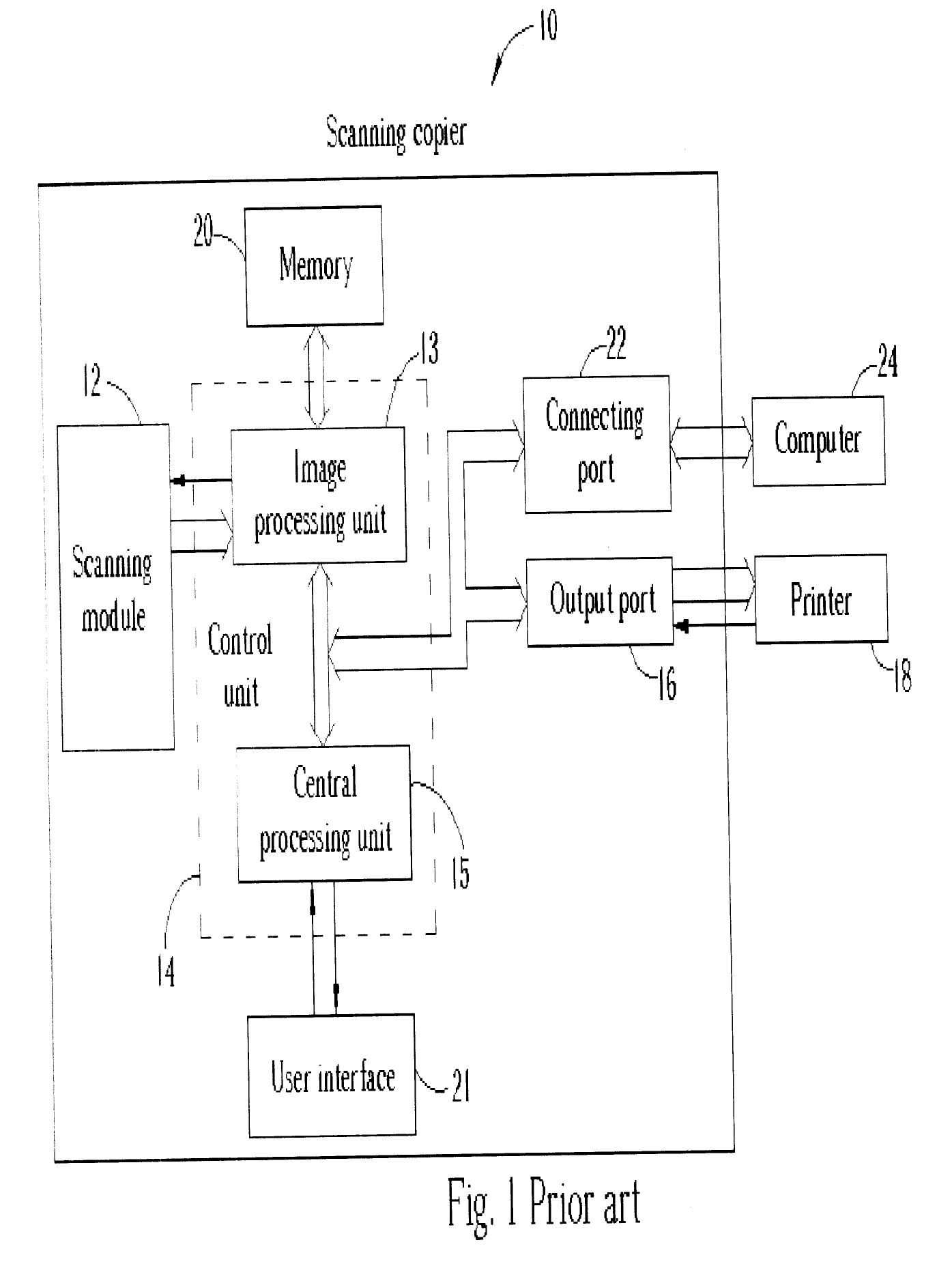

FIG. 2 is a perspective diagram of a scanning copier according to the present invention.

FIG. 3 is a functional block diagram of the scanning copier in FIG. 2.

FIG. 4 is a functional block diagram of a scanning copier according to a second embodiment.

FIG. 5 is a functional block diagram of a scanning copier according to a third embodiment.

FIG. 6 is a functional block diagram of a scanning copier according to a fourth embodiment.

### DETAILED DESCRIPTION

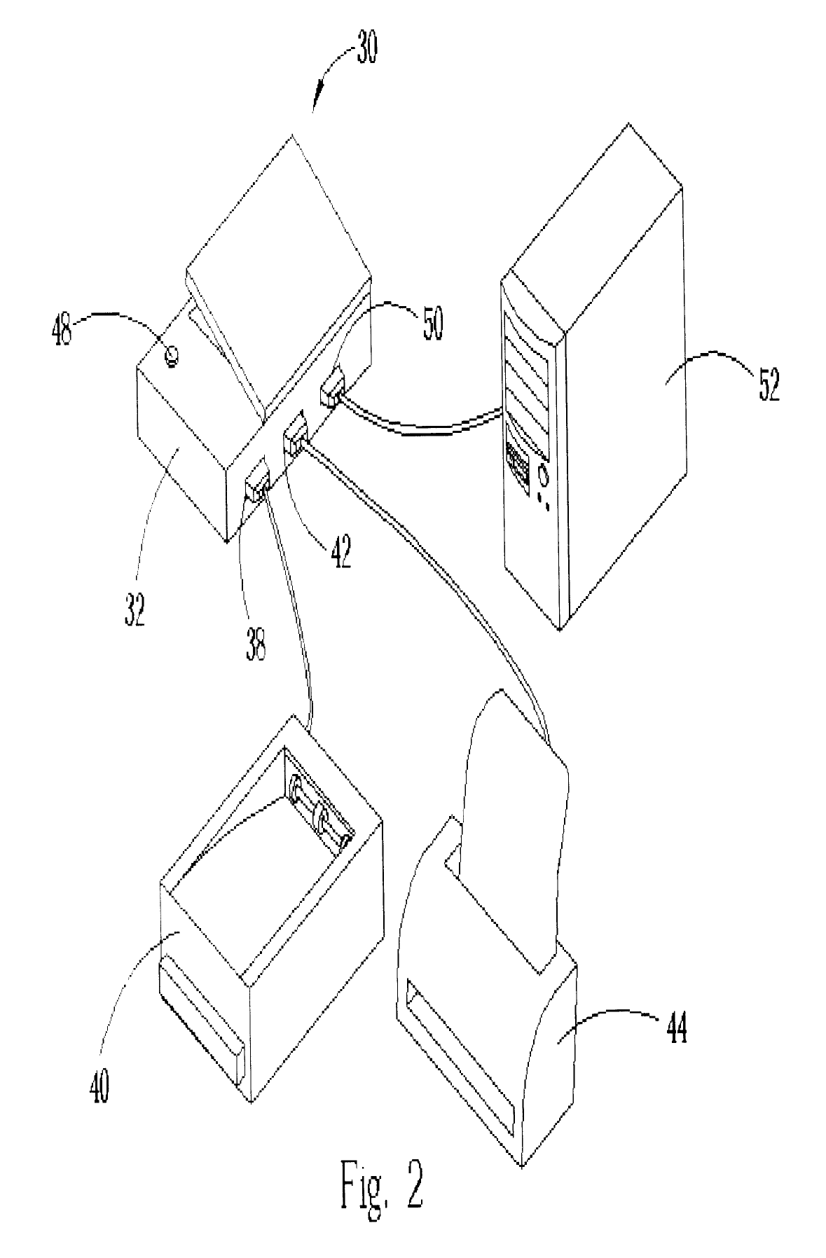

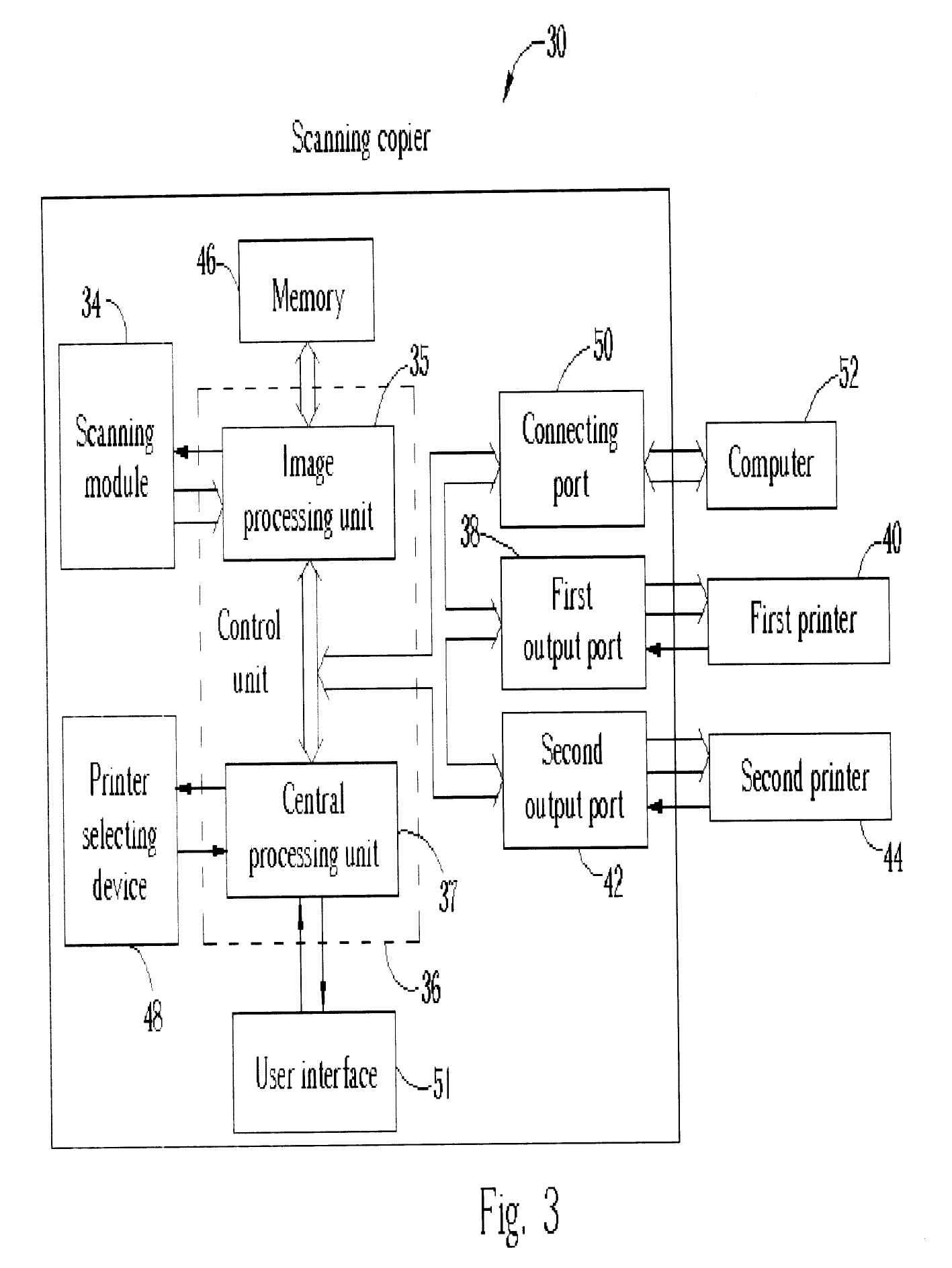

Please refer to FIG. 2 and FIG. 3. FIG. 2 is a perspective diagram of a scanning copier 30 according to the present invention. FIG. 3 is a functional block diagram of the scanning copier 30 of FIG. 2 according to a first embodiment. The scanning copier 30 comprises a housing 32, a scanning module 34 installed in the housing 32 for scanning a document and generating corresponding image data, a control unit 36 installed in the housing 32 for controlling operations of the scanning copier 30, a first output port 38 electrically connected to the control unit 36 for connecting a first printer 40, a second output port 42 electrically connected to the control unit 36 for connecting a second printer 44, a memory 46 installed in the housing 32 for storing the image data generated by the scanning module 34, a printer selecting device 48 electrically connected to the control unit 36 for choosing one of the two printers 40, 44 as an output device, a connecting port 50 installed on the housing 32 and electrically connected to the control unit 36 for connecting a computer 52, and a user interface 51. The control unit 36 comprises an image processing unit 35 for processing image data, and a central processing unit 37 for controlling the scanning process.

After the scanning module 34 finishes scanning a document, the control unit 36 transmits the image data of the document to the printer chosen by the printer selecting device 48 so as to print out a document by using the image data. The image data of the document can also be transmitted to the computer 52 through the connecting port 50. After the computer 52 processes the image data, the image data is transmitted to the first 40 or second printer 44 through the control unit 36 for printing. The computer 52 uses IEEE1284.3 communication protocol for printer selection. Alternatively, the scanning copier 30 need not be connected to the computer 52. In this scheme, after scanning of a document, the image data generated by the scanning module 34 is stored in the memory 46. The control unit 36 then transmits the image data stored in the memory 46 to the first printer 40 through the first output port 38 or to the second printer 44 through the second output port 42 for printing.

The first and second printers 40, 44 can be black-and-white laser printers and color inkjet printers. The printer selecting device 48 is used to select a printer as an output device according to current requirements. When a user wants to print a black and white image, the output device is set to the first printer 40. When the user wants to print a color image, the output device is set to the second printer 44. To accomplish the, the printer selecting device 48 can be a manually activated button or switch as illustrated in FIG. 2, or an automatic electronic switch that receives an instruction from the central processing unit 37 relating the printer 40, 44 required. In addition, the printer selecting device can also be a combination manual-automatic switch having a state selectable by the central processing unit 37 but allowing a user override.

The computer 52 can be set automatically to a specific output device according to the current printing requirements or can be set to a default printer that the computer 52 uses if no printer is previously selected.

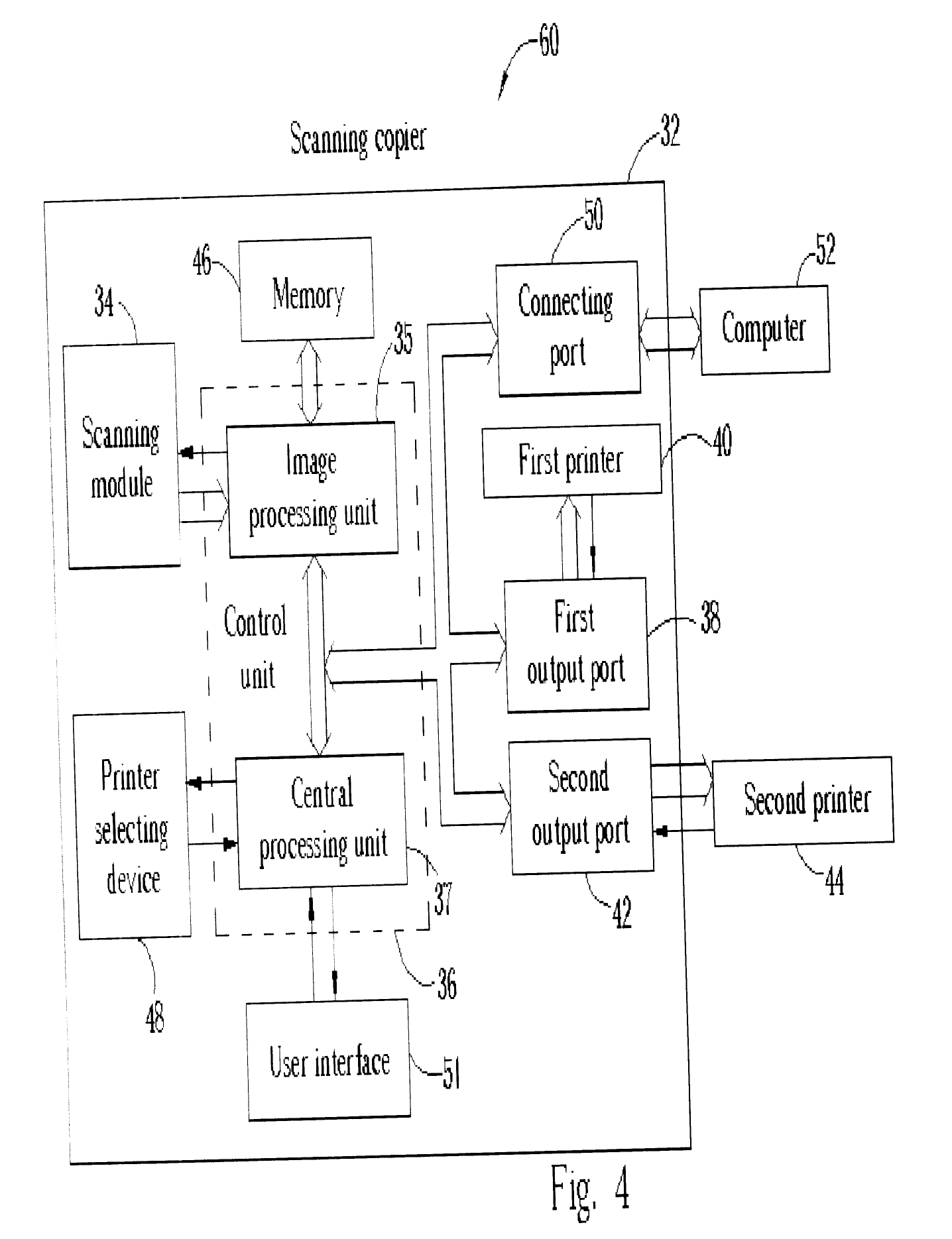

Please refer to FIG. 4. FIG. 4 is a functional block diagram of another scanning copier 60 according to a second embodiment of the present invention. As opposed to scanning copier 30, in scanning copier 60, the first printer 40 is installed inside the housing 32. This saves space, as only one machine is necessary for both scanning and printing. The first printer 40 and second printer 44 can be both installed in the housing of the scanning copier.

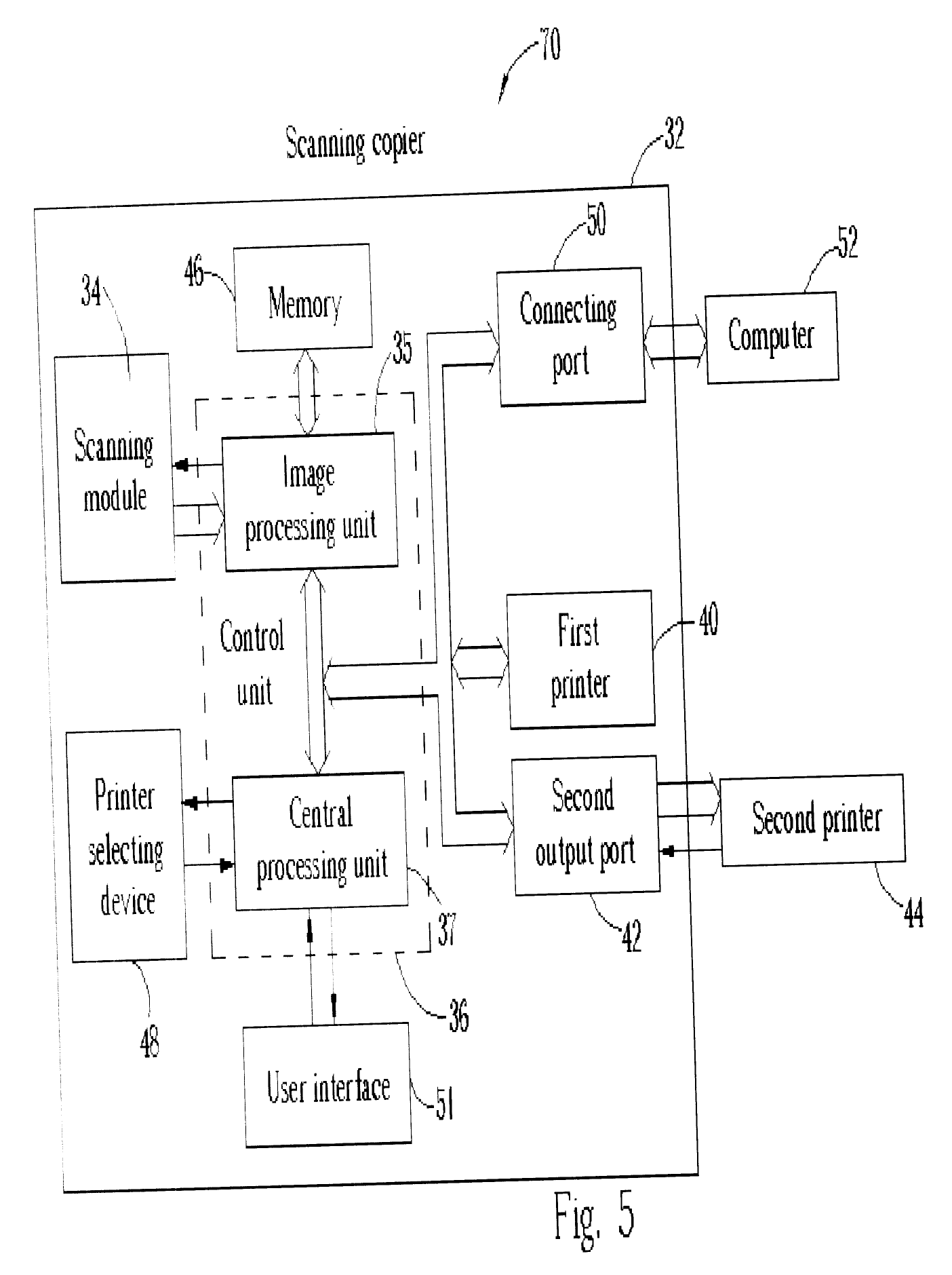

FIG. 5 illustrates a scanning copier 70 according to a third embodiment of the present invention. The scanning copier 70 is similar to the scanning copiers 30, 60, except that in the scanning copier 70, the first printer 40 is installed inside the housing 32 and directly electrically connected to the control unit 36. The first printer 40 is capable of receiving printing instructions and image data directly from the control unit 36, and providing feedback directly to the control unit 36. The direct connecting of the first printer 40 to the control unit 36 eliminates the first output port 38 required by the scanning copiers 30, 60. Modern manufacturing techniques allow for such direct connections of devices, eliminating the necessity of dedicated output port hardware. In addition, the direct connection allowed by the absence of an output port means less signal degradation and eliminates the possibility of the first printer 40 becoming mistakenly disconnected from the control unit 36. Operation of the scanning copier 70 is similar to operation of the scanner copiers 30, 60.

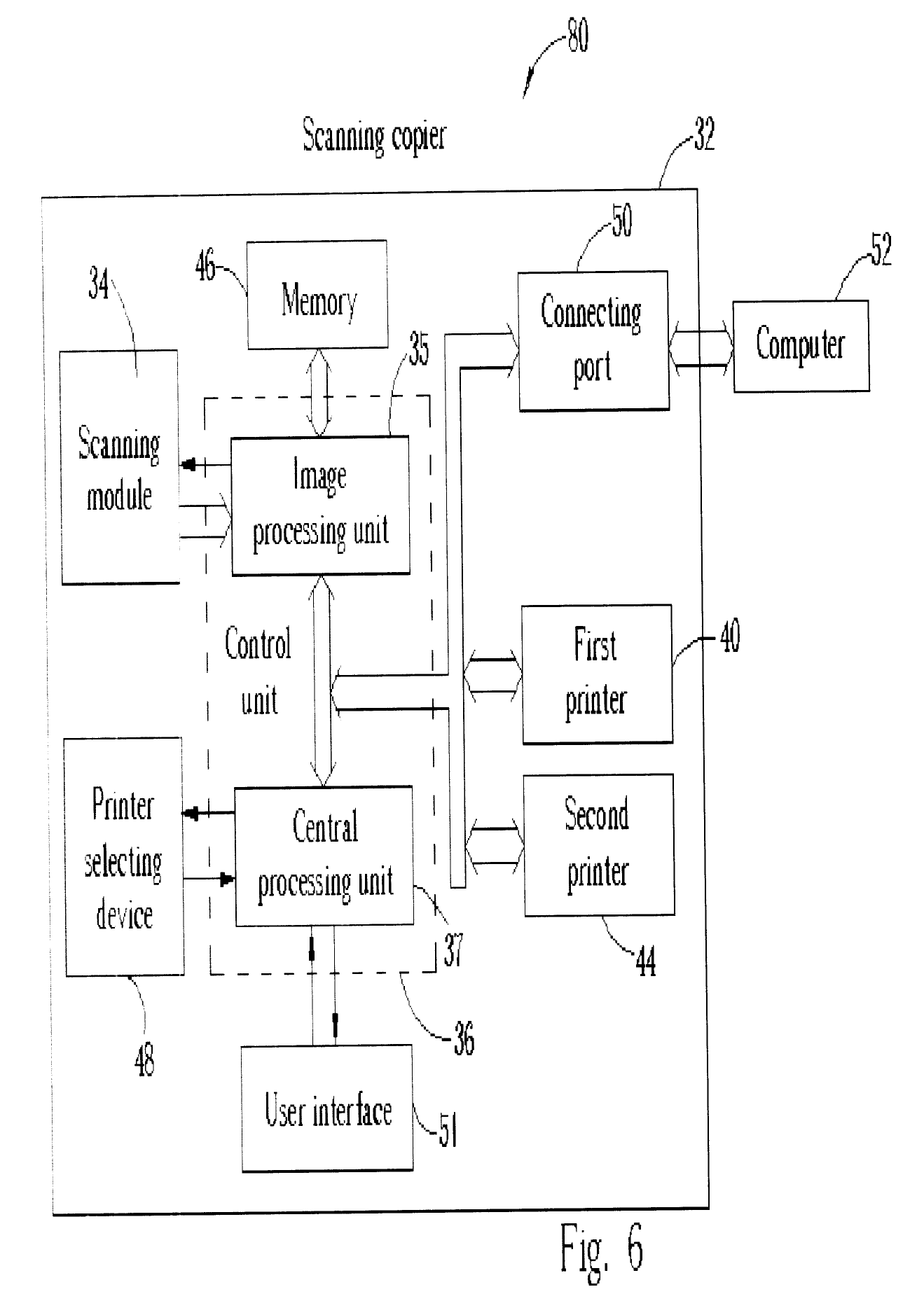

FIG. 6 illustrates a scanning copier 80 according to a fourth embodiment of the present invention. The scanning copier 80 is similar to the scanning copier 70, except that in the scanning copier 80, both the first printer 40 and the second printer 44 are installed inside the housing 32 and directly electrically connected to the control unit 36. The scanning copier 80 has two directly connected internal printers, extending the advantages of the third embodiment scanning copier 70 to the second printer 44. Operation of the scanning copier 80 is similar to operation of the scanner copiers 30, 60, 70.

Naturally, further embodiments of the present invention can be readily arrived at given the above description. For example, another embodiment can include a single internal printer directly connected to the control unit, and two external printers removably connected to the control unit through two output ports.

Compared with the prior art scanning copier 10, the scanning copiers 30, 60, 70, 80 according to the present invention offer multiple printer configurations through external and internal removable connections and direct internal portless connections. The printer selecting device 48 is used to select a printer based on current requirements, with no manual changing of printers being required.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An electronic apparatus comprising:
a housing;
a scanning module installed in the housing for scanning a document and generating corresponding image data;
a control unit installed in the housing for controlling operations of the electronic apparatus;
a first printer installed in the housing and directly electrically connected to the control unit;
a second output port electrically connected to the control unit for connecting a second printer; and
a printer selecting device electrically connected to the control unit for selecting one of the two printers as an output device;
wherein when the scanning module finishes scanning a document, the control unit transmits the image data of the document to the printer selected by the printer selecting device so as to print the document according to the image data.

2. The electronic apparatus of claim 1 further comprising a memory installed in the housing for storing the image data generated by the scanning module, wherein after the scanning module completes scanning of the document, the control unit transmits the image data from the memory to the first or second printer.

3. The electronic apparatus of claim 1 wherein one of the two printers is a black-and-white laser printer and the other is a color inkjet printer.

4. The electronic apparatus of claim 1 further comprising a connecting port installed on the housing and electrically connected to the control unit for connecting a computer, wherein after the scanning module finishes scanning the document, the control unit transmits the image data of the document to the computer through the connecting port and the computer may transmit the image data through the control unit to the first or second printer for printing.

5. The electronic apparatus of claim 1 wherein the printer selecting device is a manually actuated switch.

6. The electronic apparatus of claim 1 wherein the printer selecting device is an electronic switch adapted to receiving a switch instruction from the control unit and selecting the first or second printer based on the switch instruction.

7. The electronic apparatus of claim 1 wherein the printer selecting device is an electronic switch having a manual actuator adapted to receiving a switch instruction from the control unit and selecting the first or second printer based on the switch instruction and a position of the manual actuator.

8. An electronic apparatus comprising:
a housing;
a scanning module installed in the housing for scanning a document and generating corresponding image data;
a control unit installed in the housing for controlling operations of the electronic apparatus;
a first printer installed in the housing and directly electrically connected to the control unit;
a second printer installed in the housing and directly electrically connected to the control unit;
a printer selecting device electrically connected to the control unit for selecting one of the two printers as an output device;
wherein when the scanning module finishes scanning a document, the control unit transmits the image data of the document to the printer selected by the printer selecting device so as to print the document according to the image data.

9. The electronic apparatus of claim 8 further comprising a memory installed in the housing for storing the image data generated by the scanning module, wherein after the scanning module completes scanning of the document, the control unit transmits the image data from the memory to the first or second printer.

10. The electronic apparatus of claim 8 wherein one of the two printers is a black-and-white laser printer and the other is a color inkjet printer.

11. The electronic apparatus of claim 8 further comprising a connecting port installed on the housing and electrically connected to the control unit for connecting a computer, wherein after the scanning module finishes scanning the document, the control unit transmits the image data of the document to the computer through the connecting port and the computer may transmit the image data through the control unit to the first or second printer for printing.

12. The electronic apparatus of claim 8 wherein the printer selecting device is a manually actuated switch.

13. The electronic apparatus of claim 8 wherein the printer selecting device is an electronic switch adapted to receiving a switch instruction from the control unit and selecting the first or second printer based on the switch instruction.

14. The electronic apparatus of claim 8 wherein the printer selecting device is an electronic switch having a manual actuator adapted to receiving a switch instruction from the control unit and selecting the first or second printer based on the switch instruction and a position of the manual actuator.
